(19) United States
(12) Patent Application Publication
(10) Pub. No.: US 2006/0287917 A1
(43) Pub. Date: Dec. 21, 2006

(54) Credit/Debit Card System and Method with Use Incentives

(76) Inventor: John F. Graham SR., Austin, TX (US)

Correspondence Address: LAW OFFICES OF MARK L. BERRIER, 3811 BEE CAVES ROAD, SUITE 204, AUSTIN, TX, 78746, US

(21) Appl. No.: 11/425,428

(22) Filed: Jun. 21, 2006

Related U.S. Application Data
(60) Provisional application No. 60/692,686, filed on Jun. 21, 2005.

(51) Int. Cl. G06Q 30/00

(52) U.S. Cl. 705/14

(57) ABSTRACT

Systems and methods implemented in a computerized credit card system for providing incentives to reduce a card issuer's losses (e.g., the percentage of accrued revenues which are uncollectible, or an amount of credit extended.) One embodiment comprises a system having a data processor and a data storage unit. The data processor is configured to transfer a portion of revenues generated from card use (e.g., finance charges) to an incentive pool. The data processor periodically determines which card accounts meet eligibility requirements and transfers revenues from the incentive pool to card accounts that meet the eligibility requirements, such as having a non-negative balance. The card accounts may include both credit accounts and accounts that must be secured by deposited funds. The data processor may also be configured to evaluate credit card applications to determine the creditworthiness of applicants then establish true or secured credit accounts for more or less creditworthy applicants.

### RELATED APPLICATIONS

This application claims the benefit of U.S. Provisional Patent Application Ser. No. 60/692,686 by John F. Graham, Sr., filed Jun. 21, 2005, which is hereby incorporated by reference as if set forth herein in its entirety.

### BACKGROUND

1. Field of the Invention

The present invention relates generally to credit card systems and more particularly to systems and methods implemented in computerized systems for reducing losses resulting from uncollectible accounts.

Related Art

Credit and debit cards are well known, and many systems for providing them are known in the art. Credit and debit cards are widely used because they provide consumers with a very convenient means for purchasing goods and services (and often for financing these purchases,) while at the same time generating revenue for the companies that provide the credit/debit card systems (through interest which accrues on balances, other finance charges, and transaction fees.)

Some companies encourage the use of their cards (particularly credit cards) by implementing incentive programs. These incentive programs entice consumers to use their credit cards by promising various different types of rewards, such as cash back (e.g., a percentage of selected purchases,) frequent-flier miles which can be redeemed for travel on participating airlines, bonus points which may be redeemed by the credit card company for consumer goods, and so on. As a result of these incentive programs, credit cards are becoming more widely used.

There are many examples of patented credit and debit card systems. For example: U.S. Pat. No. 6,070,153 to Simpson discloses a System and Method for Automatically Investing a Portion of a Credit Card Interest Charged Amount in an Investment Account; U.S. Pat. No. 5,297,026 to Hoffman discloses a System for Promoting Account Activity that subsidizes above-market rates of interest on investment funds; U.S. Pat. No. 5,787,404 to Fernandez-Holmann discloses a Credit-Card Based Retirement Fund System and Method; and U.S. Pat. No. 6,631,358 to Ogilve discloses Promoting Savings by Facilitating Incremental Commitments made with Credit Card and other Consumer-initiated Transactions.

While credit card incentive programs increase the use of credit cards by consumers, there remain several drawbacks to conventional credit card systems and their incentive programs. For example, from the perspective of the consumer, credit card use incentives such as receiving cash back on purchases may be attractive to many credit card users, but the incentives may be available to only a restricted group of these people (e.g., those users who have high credit ratings.) The incentives may not even be made available to consumers to do not have high credit scores. It would therefore be desirable to provide credit card systems for which incentive programs are more widely available.

From the perspective of the credit card company, incentive programs encourage the use of their credit cards, but these programs do not address one of the factors most critical to their revenues—collections. Conventional incentive programs increase the use of credit cards, but they do not affect the collectibility of finance charges accrued through use of the credit cards. Typically, 20% of these finance charges are uncollectible, regardless of the level of use of the credit cards. It would therefore be desirable to provide credit card systems in which revenue losses corresponding to uncollectible finance charges are reduced.

### SUMMARY OF THE INVENTION

One or more embodiments of the invention are described below. It should be noted that these and any other embodiments described below are exemplary and are intended to be illustrative of the invention rather than limiting.

One or more of the problems outlined above may be solved by the various embodiments of the invention. Broadly speaking, the invention relates to systems and methods implemented in a computerized credit card system for providing incentives to reduce the percentage of accrued revenues which are uncollectible. One embodiment comprises a system having a data processor and a data storage unit. The data processor in this embodiment is configured to transfer a portion of the revenues generated from card use to an incentive pool. The data processor periodically determines which card accounts meet a set of eligibility requirements and transfers at least a portion of the revenues in the incentive pool to those card accounts that meet the eligibility requirements. The revenues transferred to the incentive pool may, for example, be a portion of the finance charges collected on the accounts. In one embodiment, the eligibility requirements simply comprise having a non-negative balance. The card accounts may include both credit accounts and accounts that must be secured by deposited funds. The data processor may also be configured to evaluate credit card applications to determine the creditworthiness of each applicant. The data processor may then establish true credit accounts for more creditworthy applicants and secured credit accounts for less creditworthy applicants.

Another embodiment comprises a computer implemented method including the steps of transferring card use revenues to an incentive pool, determining whether card accounts meet a set of eligibility requirements and transferring at least a portion of the revenues in the incentive pool to the card accounts that meet the eligibility requirements. The eligibility requirements may simply consist of having a non-negative balance. The card accounts may include both credit accounts and secured accounts. The revenues transferred to the incentive pool may comprise finance charges collected on the card accounts. The method may further comprise evaluating credit card applications, determining the creditworthiness of applicants, and establishing credit accounts for more creditworthy applicants and secured accounts for less creditworthy applicants.

One embodiment of the present invention is a combination credit and debit card system with use incentives. Potential card consumers are initially presented with a unified card application. Depending upon the creditworthiness of the consumer as determined by the unified application, a consumer may be offered a credit card or may be offered a debit card backed by a financial account. This is a novel feature of the present invention, as a single application allows multiple types of cards to be issued. Those skilled in the art will appreciate that a secured credit card, backed by a bond or deposit equal to the credit limit of the secured credit card, is within the spirit and scope of the invention and equates to the debit card described herein. In this embodiment, a positive credit card balance may be maintained by the consumer, and the card issuer pays interest on the balance. Interest paid on the card may be at a rate better than the standard market rate, as the consumer with a positive balance may be paid from the revenue that the card issuer receives from the card. The card issuer pays interest to positive account holders by creating an interest pool from the interest charged to card holders with negative account balances, and using a percentage of the interest pool to pay interest to consumers with positive account balances. Optionally, the credit card issuer may also add other card revenue, such as transaction fee and other card fee revenue, to the interest pool.

Numerous additional embodiments are also possible.

### BRIEF DESCRIPTION OF THE DRAWINGS

Various objects and advantages of the invention may become apparent upon reading the following detailed description and upon reference to the accompanying drawings.

FIG. 1 is a flow chart illustrating a method by which credit card accounts are established in accordance with one embodiment.

FIG. 2 is a flow chart illustrating a method by which money is deposited into an incentive pool and then distributed to qualified account holders in accordance with one embodiment.

FIG. 3 is a diagram illustrating structure of a data processing system in accordance with one embodiment.

FIG. 4 is a flowchart of an alternative embodiment of a credit/debit card application process in accordance with one embodiment.

FIG. 5 is a flowchart of the incentive program of a credit card system in accordance with one embodiment.

FIG. 6 is a flowchart of an incentive program of a debit card system in accordance with one embodiment.

FIG. 7 is a flowchart of an incentive program in accordance with one embodiment.

FIG. 8 is a flowchart of cashflows in accordance with one embodiment.

FIG. 9 is a flowchart of a credit limit check in accordance with one embodiment.

While the invention is subject to various modifications and alternative forms, specific embodiments thereof are shown by way of example in the drawings and the accompanying detailed description. It should be understood that the drawings and detailed description are not intended to limit the invention to the particular embodiments which are described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

Broadly speaking, the invention relates to systems and methods implemented in a computerized credit card system for providing incentives to reduce the percentage of accrued revenues which are uncollectible. In one embodiment, credit cards are issued to account holders. A first portion of the account holders meet a particular set of credit requirements, and the credit cards issued to these account holders are true credit cards. A second portion of the account holders do not meet these credit requirements, so the cars issued to these account holders are secured by money which is deposited with the credit card company. A portion of the revenues collected by the credit card company are designated as an incentive pool. On a periodic (e.g., monthly) basis, the credit card company determines which of the account holders has a non-negative balance and distributes all or a portion of the revenues in the incentive pool to these account holders. No distribution from the incentive pool is made to account holders who have negative balances.

In this exemplary embodiment, consumers first interact with the credit card system when they apply for a credit card. A single application is used for all applicants. When an application is received by the credit card company, the application is evaluated to determine whether the applicant meets a set of credit-related requirements. If the requirements are met, the applicant is considered creditworthy, and if the requirements are not met, the applicant is considered not to be creditworthy.

A credit card is then issued to the applicant. The credit card will, by all appearances, be the same, regardless of whether or not the applicant is considered to be creditworthy. The card will, however, be associated with an account for the applicant which may have different conditions of use, depending upon whether or not the applicant is creditworthy. If the applicant (now the account holder) is creditworthy, the account will be a true credit account, and the account holder will be able to charge purchases to the account and periodically pay back the credit card company for the charges. If the account holder is not creditworthy, the account will be secured by a deposit which the account holder provides to the credit card company. In this embodiment, the charges on the credit card are not immediately taken out of the deposit, but are instead billed to the account holder and are paid by the account holder in the same manner as creditworthy account holders. The deposit is only used as payment in the event that the account holder fails to timely pay the balance due on the account.

In this embodiment, all account holders are encouraged to timely pay the balances due on their accounts by allowing those who do so to participate in distributions from an incentive pool. As revenues are generated by the credit card system (e.g., through collection of transaction charges, finance charges, etc.,) a portion of these revenues are deposited in the incentive pool. Periodically (e.g., on a monthly basis,) it is determined which of the account holders, whether creditworthy or not, have maintained a non-negative balance in their accounts. For the true credit accounts, this may mean that accrued charges are paid by a designated due date. For the secured credit accounts, this may mean the same thing, or it may mean that the account has a positive balance after applying the deposit to the accrued charges. Thus, prompt payment of accrued charges is rewarded by participation in the incentive pool.

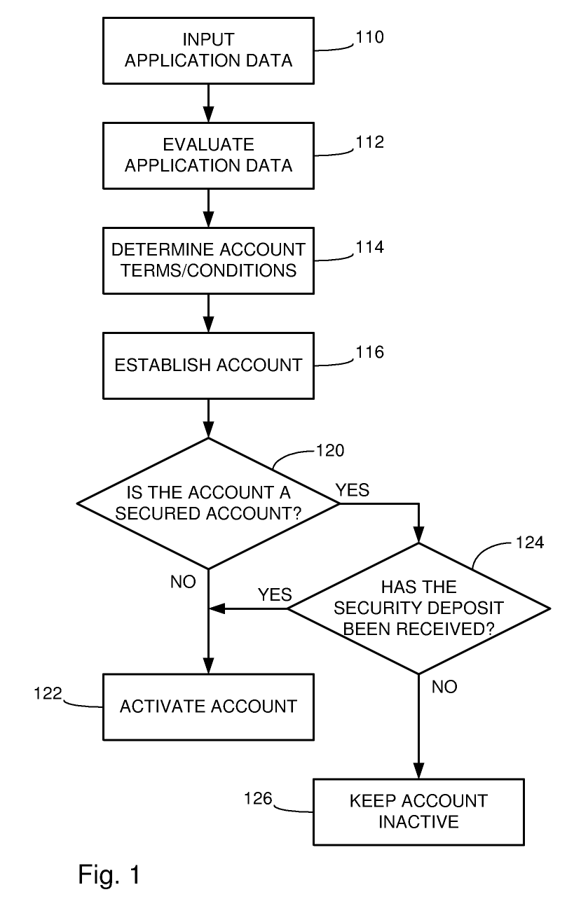

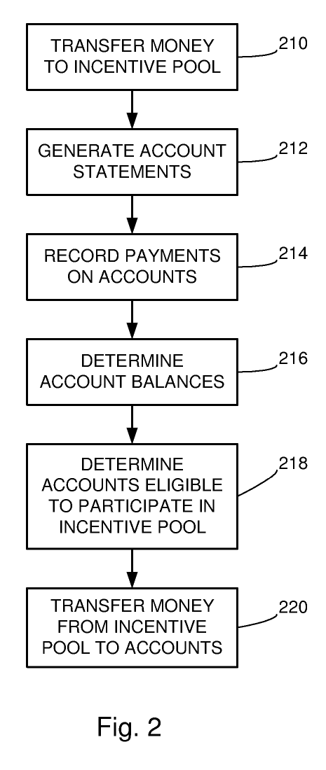

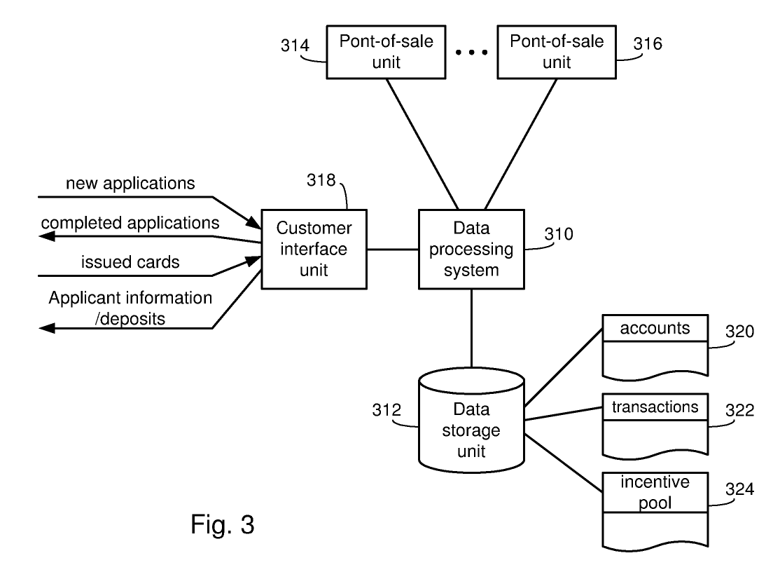

Referring to FIGS. 1-2, a first exemplary embodiment is illustrated. FIG. 1 is a flow chart illustrating a method by which credit card accounts are established in this embodiment. FIG. 2 is a flow chart illustrating a method by which money is deposited into an incentive pool and then distributed to qualified account holders. FIG. 3 is a diagram illustrating structure of a data processing system in which the methods of FIGS. 1 and 2 are implemented. It should be noted that the steps of the methods depicted in FIGS. 1 and 2 are implemented electronically in the data processing system of FIG. 3.

As depicted in FIG. 1, this embodiment implements a unified application process which serves both to simplify the application process for the credit card company and to allow broader participation by customers. The process begins with the delivery of account applications to a group of customers (potential account holders,) followed by the return of complete applications by one or more of these customers. These steps are not included in the figure because the figure focuses on the portion of the process that may be automated by the data processing system in which it is implemented. When a completed application is received, the corresponding application data is entered into the data processing system (110.) The application data is then evaluated (112,) and it is determined what type of account conditions will be applied to a credit card account that will be offered to the applicant (114.)

In this embodiment, all applicants (customers who return completed applications) will receive an offer to establish a credit card account, but the account terms and conditions will vary from applicant to applicant, depending upon the evaluation of each customer's creditworthiness. Based upon the terms and conditions resulting from an applicant's evaluation, an account will be established for the applicant (116.) In this embodiment, the account may be a true credit account, or a secured credit account. A credit card will then be provided to the applicant, along with information identifying the terms and conditions associated with the corresponding account. If, at 120, the account is a true credit account, no security deposit is required, so the account is activated (122,) typically when the applicant places a telephone call to an automated account activation portion of the data processing system indicating receipt of the credit card and acceptance of the account's terms and conditions. If, on the other hand, the account is a secured account (120,) the system waits until confirmation is received that a security deposit has been received from the applicant (124,) and then the account is activated (122.) If no security deposit is received, the account remains inactive (126) and may be terminated if the deposit is not received before a predetermined date.

Referring now to FIG. 2, the process by which an incentive portion of the system is implemented is shown. It is assumed that there are a set of established accounts (both true credit accounts and secured accounts,) and that operations typical to any credit card system are being carried out as known in the field. These typical operations may include, for example, recording transactions associated with the various accounts, generating statements for the accounts, receiving and crediting payments, etc. Based upon these normal operations, certain amounts of money are transferred to an incentive pool (210.) The amounts transferred to the incentive pool may be based on various factors and may include, for example, a percentage of each transaction amount, a percentage of finance charges collected, and so on.

As in conventional systems, the process includes periodically generating account statements (212.) The account statements are delivered to the account holders, and payments are received from the account holders with respect to the statements. As the payments are received, they are recorded (214) and the balances on each of the accounts are determined (216.) Based on the account balances, it is then determined which of the account holders are eligible to participate in distributions from the incentive pool (218.) In one embodiment, eligibility to participate in incentive pool distributions is a simple matter of determining which accounts have positive balances. Those accounts which have positive (or non-negative) balances are eligible, while those with negative balances are not. Distributions are then made from the incentive pool to the eligible accounts (220.) The distribution to each account may be computed in various ways, such as dividing the pool equally among eligible accounts, basing the distribution on the number of transactions or aggregate transaction amount associated with the account, and so on.

Referring now to FIG. 3, a diagram illustrating a system suitable for implementing the processes of FIGS. 1 and 2 is shown. The system is built around a data processing system 310, which may be any suitable type of computer system. In this embodiment, data processing system 310 is connected to a data storage unit 312, point-of-sale units 314-316 and customer interface unit 318. Much of the account application and establishment process is carried out through customer interface unit 318. Data processing system 310 may initially have a list of potential applicants stored in data storage unit 312. This list may be provided to customer interface unit 318, which would then generate applications for delivery to the prospective applicants. Complete applications would be returned, and corresponding data entered through customer interface unit 318. Customer interface unit 318 could utilize either mail-based communications or electronic communications (e-mail or Internet traffic) to perform these functions.

After an applicant's information is received and transfer to data processing system 310, it is stored in data storage unit 312. Evaluation of the applicant information is performed by data processing system 310, and results of the evaluation are stored in data storage unit 312. Based on the evaluation results, data processing system 310 directs customer interface unit 318 to generate credit cards and account information to be mailed to corresponding applicants. Offer acceptances (e.g. automated credit card activation or receipt of deposits for secured accounts) are handled by customer interface unit 318, and the acceptance information is provided to data processing system 310 for activation of corresponding accounts.

Data processing system 310 is, as noted above, designed to implement conventional credit card processing functions. For example, as account holders make purchases and point-of-sale (e.g., 314-316,) the transactions are approved through communications with data processing system 310 and recorded by the data processing system on data storage unit 312. Data processing system 310 maintains a variety of database tables on data storage unit 312, such as an account information table 320 and a transaction table 322. Based upon the transaction and account information stored in these tables, data processing system 310 generates periodic statements and provides these two customer interface unit 318 to be forwarded to the account holders. Data processing system 310 also uses the account and transaction information to compute amounts of money which are to be transferred to an incentive pool, and corresponding information 324 is stored on data storage unit 312.

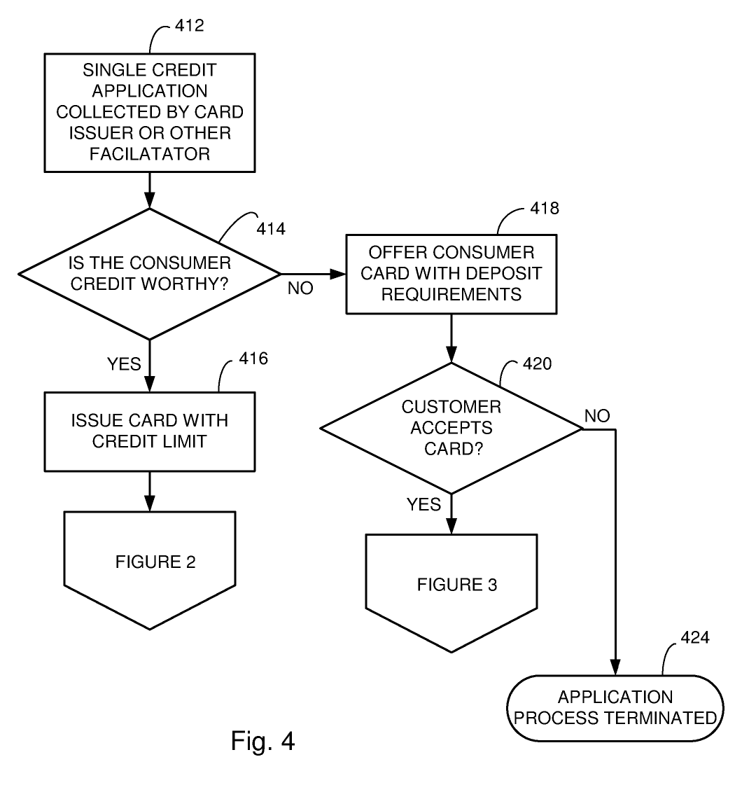

Referring now to FIGS. 4-9, an alternative process is described. FIGS. 4-9 are a set of flowcharts illustrating a combination credit and debit card system with use incentives (410.)

In FIG. 4, a unified application 412 is sent to potential consumers. The completed application is used to determine a credit rating for the consumer 414. If the credit rating exceeds a predetermined score, a credit card is issued to the consumer 416. If the credit rating does not exceed the predetermined score, the consumer is offered a debit card 418, which may be accepted or rejected 420 by the consumer. If a consumer rejects a debit card, the application process is terminated 424.

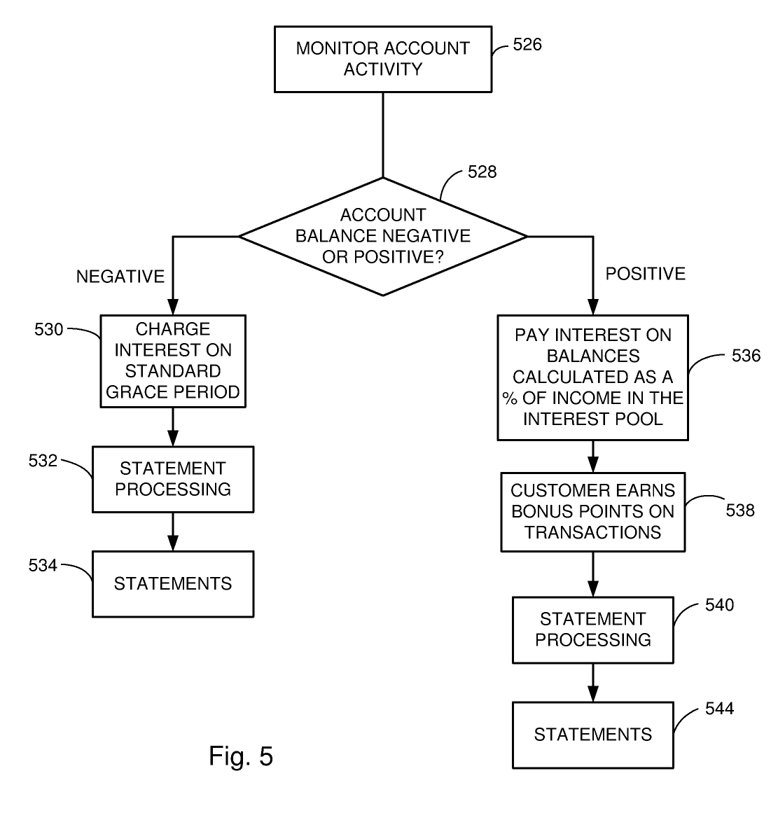

In FIG. 5, similar to a conventional credit card, the credit card activity of a credit card holder in this embodiment is monitored for activity 526, and the overall status of the account is noted 528. A consumer is charged interest (subject to a grace period on new purchases) when a balance is owed 530 and a statement is processed 532 and delivered to the consumer 534. In one embodiment, when the consumer maintains a positive balance on the card, the card may be treated as a savings account that accrues interest not only at market rates, but offers a return based upon the profitability of the card based on the interest it charges consumers with a negative balance. If a consumer maintains a positive balance, interest is paid to the consumer 536. The interest paid to the consumer includes a return based on the income of the card issuer based on the interest it collects from consumers that maintain a balance. Additionally, the consumer is awarded bonus points on transactions 538, similar to card incentive programs generally known in the art. A statement is processed 540 and delivered to the consumer 544.

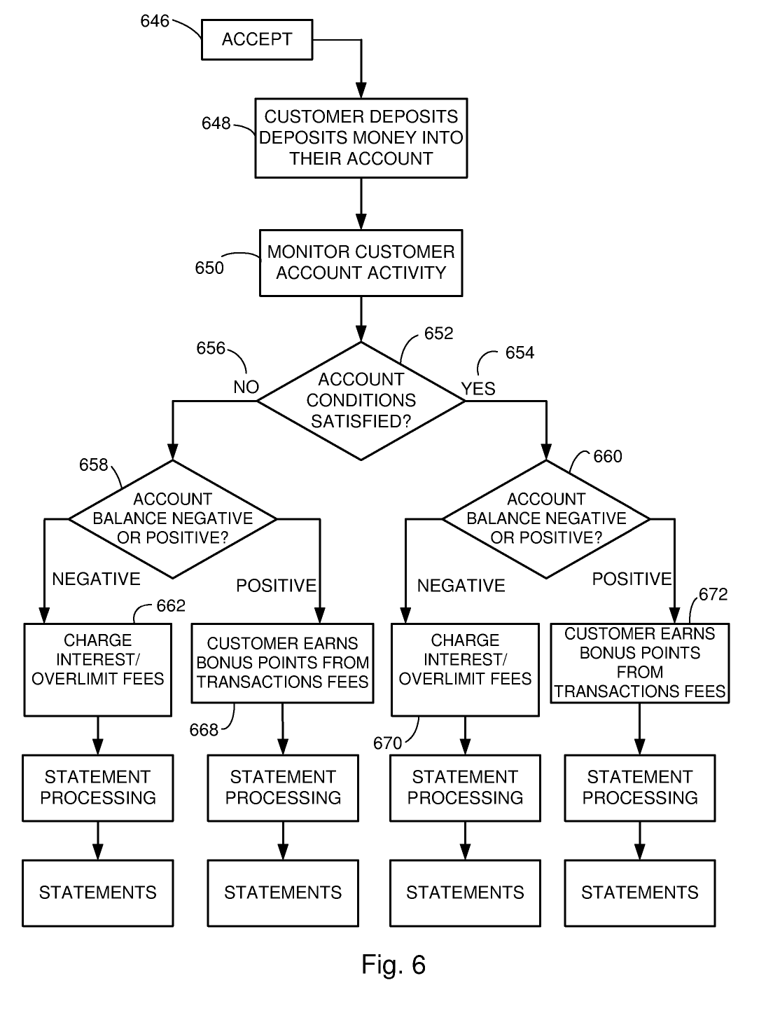

In FIG. 6, similar to many debit cards and secured credit cards, the debit card of the present embodiment requires a consumer that accepts the debit card 646 to deposit money into an account 648. The account activity is then monitored 650 by the card issuer, and is subject to certain conditions 652, such as minimum balance requirements, set by the card issuer. Adherence to the predetermined conditions will enable the issuer to impose different account rules 652. If the conditions are satisfied, one set of predetermined rules are followed 654. If the conditions are not satisfied, another set of predetermined rules are followed 656. In the present embodiment, no differentiation is made between account conditions, but the process allows for such variation. The account is also monitored to determine if the account balance is negative or positive 658, 660. If the account balance is negative, the consumer may be declared to be overlimit and prevented from incurring additional charges 662, 670. Alternatively, interest and overlimit fees may be charged 662, 670. If the account balance is positive, the debit card functions similar to incentive credit cards known in the art, and the consumer is rewarded with bonus points 668, 672 that are funded by the transaction fees the card issuer charges the merchant.

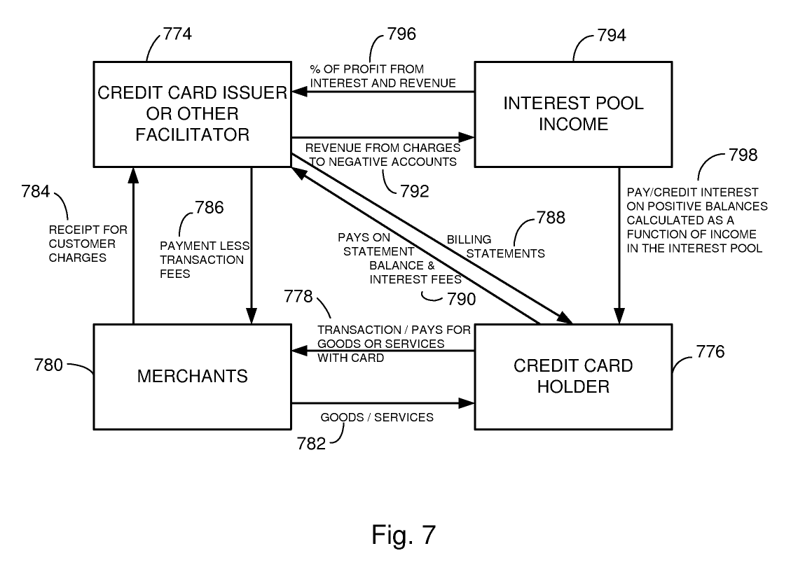

In FIG. 7, a card issuer 774 issues the combination credit and debit card with use incentives of the present embodiment to a credit card holder 776. The credit or debit card holder 776 uses the card to pay for transactions 778 with merchants and service providers 780, which provide goods and services 782 in exchange for the charges made to the card 778. Receipts for such transactions are presented 784 to the card issuer 774 which provides merchants 780 with cash for the transactions, but withholds a processing or transaction fee 786. The card issuer 774 presents the card holder 776 with a statement of charges 788, and the card holder 776 pays the amount of the statement 790. Should the card holder 776 not pay the statement in a timely manner, additional interest and fees are charged by the card issuer 774 and paid 790 by the card holder 776. The preceding portion of this flowchart is known in the art. However, a novel part of the present embodiment is that the card issuer 774 places the interest income from card holders 776 into an interest pool 792. The card issuer 774 retains a predetermined percentage of the interest pool 794 as profit and overhead, and uses a predetermined percentage to reward 798 card holders 776 that maintain a positive account balance.

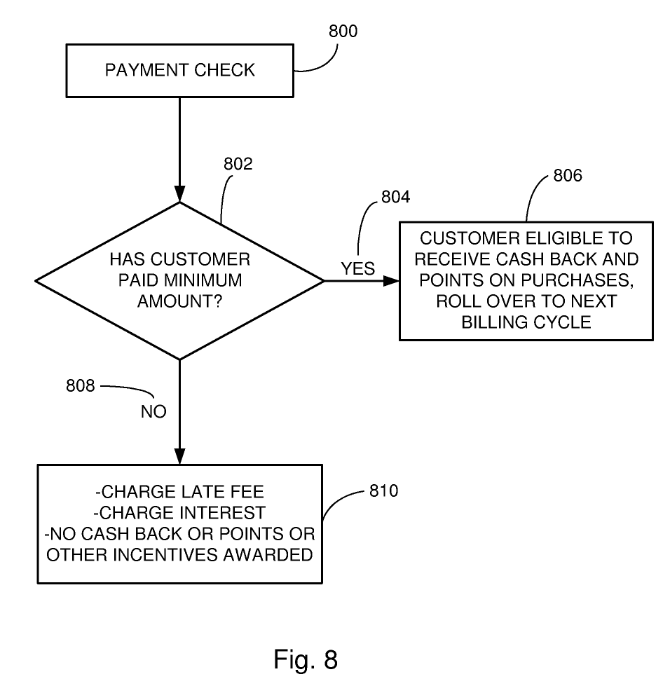

In FIG. 8, the determination process of eligibility for card profitability sharing is illustrated. When a payment 800 is received from a consumer, it is determined whether the payment pays the card holder account in its entirety or meets a minimum payment 802. It is noted that a payment may be received via check, cash, an electronic transaction, or via another of other methods that will be readily apparent to those trained in the art. If a preset standard is met 804, the consumer is eligible for incentives 806 for the next billing cycle. The present standard is shown in the illustration as meeting the minimum payment, but different standards, such as payment of the total balance, may be employed, or tiers of eligibility for interest sharing versus incentive rewards may be established. If the preset standard is not met 808, interests and fees will be charged 810 and eligibility for incentives may be voided for the next billing cycle.

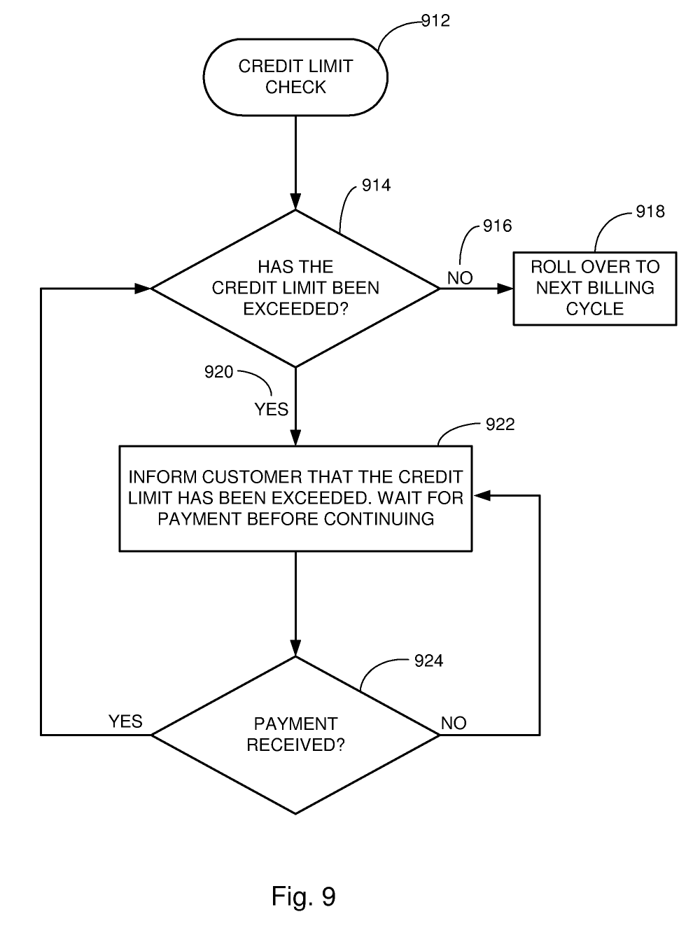

In FIG. 9, a flowchart of the credit limit check for continued card use and acceptance is illustrated and will be described. This process is known in the art, and is conducted every time a consumer attempts to use the card to complete a transaction. When a consumer presents a card to complete a transaction, approval to charge the transaction comprises conducting a check to determine whether the transaction complies with conditions (e.g., does not exceed a credit limit) set by the card issuer for the particular card holder. The credit limit check 912 calculates whether the card holder credit limit will be exceeded 914 by the transaction. If the limit is not exceeded 914, the charge will be rolled to the next billing statement 918. If the limit is exceeded, 920, the transaction is rejected and the consumer is informed that the limit has been exceeded 922. Transactions that exceed the limit are not allowed, and if the limit has been exceeded, no further transactions are allowed until a payment 924 by the card holder allows new transactions to remain under the credit limit.

Those of skill in the art will understand that information and signals may be represented using any of a variety of different technologies and techniques. For example, data, instructions, commands, information, signals, bits, symbols, and the like that may be referenced throughout the above description may be represented by voltages, currents, electromagnetic waves, magnetic fields or particles, optical fields or particles, or any combination thereof. The information and signals may be communicated between components of the disclosed systems using any suitable transport media, wired or wireless networks, telephone systems, wires, metallic traces, vias, optical fibers, and the like.

Those of skill will further appreciate that the various illustrative logical blocks, modules, circuits, and algorithm steps described in connection with the embodiments disclosed herein may be implemented as electronic hardware, computer software (including firmware,) or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with general purpose processors or other devices. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in software (program instructions) executed by a processor, or in a combination of the two. Software may reside in RAM memory, flash memory, ROM memory, EPROM memory, EEPROM memory, registers, hard disk, a removable disk, a CD-ROM, or any other form of storage medium known in the art. Such a storage medium containing program instructions that embody one of the present methods is itself an alternative embodiment of the invention. One exemplary storage medium may be coupled to a processor, such that the processor can read information from, and write information to, the storage medium. In the alternative, the storage medium may be integral to the processor. The processor and the storage medium may reside, for example, in an ASIC. The ASIC may reside in a user terminal. The processor and the storage medium may alternatively reside as discrete components in a user terminal or other device.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A system comprising:
a data processor; and
a data storage unit;
wherein the data processor is configured to
transfer a portion of card use revenues to an incentive pool,
determine a first portion of card accounts that meet a set of eligibility requirements, and
transfer at least a portion of the revenues in the incentive pool to the first portion of card accounts.

2. The system of claim 1, wherein the set of eligibility requirements comprises having a non-negative balance.

3. The system of claim 1, wherein the card accounts include a set of credit accounts and a set of secured accounts.

4. The system of claim 3, wherein for the set of credit accounts, the set of eligibility requirements comprises paying a statement balance by a designated due date.

5. The system of claim 3, wherein for the set of credit accounts, the set of eligibility requirements comprises paying a minimum payment amount by a designated due date.

6. The system of claim 3, wherein for the set of secured accounts, the set of eligibility requirements comprises the sum of a deposit balance and a credit balance being positive.

7. The system of claim 3, wherein the portion of card use revenues transferred to the incentive pool comprises finance charges collected on the card accounts.

8. The system of claim 1, wherein the data processor is further configured to:
evaluate a plurality of credit card applications;
determine a level of creditworthiness associated with each of the credit card applications;
establish credit accounts corresponding to ones of the credit card applications for which the level of creditworthiness exceeds a threshold level; and
establish secured accounts corresponding to ones of the credit card applications for which the level of creditworthiness is less than a threshold level.

9. A method comprising
transferring a portion of card use revenues to an incentive pool;
determining a first portion of card accounts that meet a set of eligibility requirements; and
transferring at least a portion of the revenues in the incentive pool to the first portion of card accounts.

10. The method of claim 9, wherein determining the first portion of card accounts that meet the set of eligibility requirements the set of eligibility requirements comprises determining which of the card accounts have non-negative balances.

11. The method of claim 9, wherein the card accounts include a set of credit accounts and a set of secured accounts.

12. The method of claim 11, wherein for the set of credit accounts, the set of eligibility requirements comprises paying a statement balance by a designated due date.

13. The method of claim 11, wherein for the set of credit accounts, the set of eligibility requirements comprises paying a minimum payment amount by a designated due date.

14. The method of claim 11, wherein for the set of secured accounts, the set of eligibility requirements comprises the sum of a deposit balance and a credit balance being positive.

15. The method of claim 11, wherein the portion of card use revenues transferred to the incentive pool comprises finance charges collected on the card accounts.

16. The method of claim 9, further comprising:
evaluating a plurality of credit card applications;
determining a level of creditworthiness associated with each of the credit card applications;
establishing credit accounts corresponding to ones of the credit card applications for which the level of creditworthiness exceeds a threshold level; and
establishing secured accounts corresponding to ones of the credit card applications for which the level of creditworthiness is less than a threshold level.

17. A method implemented in a data processing system for credit and debit cards comprising:
determining credit ratings for a plurality of consumers;
establishing a credit card account each consumer that exceeds a predetermined credit rating; and
establishing a debit card account to each consumer that does not exceed a predetermined credit rating.

18. The method of claim 17, further comprising:
maintaining an incentive pool;
transferring a predetermined portion of revenue generated from use of the credit card accounts and debit card accounts into an interest pool;
determining which of the credit card accounts and debit card accounts maintain non-negative account balances;
transferring a predetermined percentage of the incentive pool to the credit card accounts and debit card accounts having non-negative account balances.

19. The method of claim 18 further comprising:
charging interest on negative account balances; and
accruing a portion of the charged interest to the incentive pool.

20. The method of claim 18 further comprising:
collecting transaction fees from merchants that accept cards associated with the credit card accounts and debit card accounts for consumer transactions; and
transferring a portion of the transaction fees to the incentive pool.
